(19) United States
(12) Patent Application Publication
(10) Pub. No.: US 2003/0210381 A1
(43) Pub. Date: Nov. 13, 2003

(54) Method of correcting for distortion of projected image, distortion correcting program used in same method, and projection-type image display device

(75) Inventor: Youichi Itaki, Tokyo (JP)

Correspondence Address: SUGHRUE MION, PLLC, 2100 PENNSYLVANIA AVENUE, N.W., WASHINGTON, DC, 20037, US

(73) Assignee: NEC VIEWTECHNOLOGY, Ltd.

(21) Appl. No.: 10/430,263

(22) Filed: May 7, 2003

(30) Foreign Application Priority Data
May 10, 2002 (JP) 136161/2002

(51) Int. Cl. G03B 21/00

(52) U.S. Cl. 353/70

(57) ABSTRACT

A distortion correcting method is provided which is capable of correcting for distortions of projected images without a need for additionally placing a display unit or a test image displaying unit and by a low-cost configuration and by a simple operation. The distortion correcting method includes a first step of moving a pointer on a screen according to operations of an operator and of sequentially displaying correction reference points which correspond to correction points for a projected image and being designated by operations of the operator on the screen, and then of displaying a correction contour frame on the screen, wherein the correction contour frame is obtained by connecting at least two being adjacent to each other out of the correction reference points, a second step of determining the correction contour frame according to an instruction for determining the correction contour frame from the operator and of calculating a correction parameter according to a distance between each of the correction points for the projected image and the correction reference points of the correction contour frame corresponding to each of the correction points, and a third step of correcting for distortions of projected images based on the correction parameter.

### BACKGROUND OF THE INVENTION

1. Field of the Invention

The present invention relates to a method for correcting for distortion of a projected image, a distortion correcting program used in same method, and a projection-type image display device and more particularly to the method for correcting for the distortion of the projected image caused by projecting an image with a projection optical axis being tilted from normal to the screen, the distortion correcting program used in same method, and the projection-type image display device to which the above method for correcting for the distortion of the projected image is applied.

The present application claims priority of Japanese Patent Application No. 2002-136161 filed on May 10, 2002, which is hereby incorporated by reference.

2. Description of the Related Art

A projection-type image display device (projector), after having modulated light emitted from a light source using a display device such as a liquid crystal panel or a like, projects the modulated light onto a screen through an optical lens to achieve display of an image. In many cases, the projection-type image display device projects the image onto a screen with a projection optical axis being tilted from normal to the screen rather than with the screen and the projection optical axis being intersected at right angles. In this case, for example, a rectangular image is displayed on the screen as the image having been distorted to be trapezoidal.

Then, in the conventional projection-type image display device, corrections for distortion of projected image caused by projecting the image with the projection optical axis being tilted from normal to the screen are made. Technology of a conventional projection-type image display device as described below is disclosed, for example, in Japanese Patent Application Laid-open No. 2002-6391. That is, in the disclosed conventional projection-type image display device, first, a graphic pattern having a rectangular shape or a like is displayed on a display device being placed independent of an existing screen and, at a same time, the same graphic pattern as above is displayed on the screen. Next, vertices (corrected points) of the graphic pattern having the rectangular shape or a like being displayed on the display device are moved and the resulting graphic pattern having a deformed quadrilateral shape are displayed on the display device and, at this time, deformation ratio parameters of the graphic pattern having the deformed quadrilateral shape to its original graphic pattern are calculated and, at the same time, the graphic pattern having the deformed quadrilateral shape is displayed on the screen. If the graphic pattern having the deformed quadrilateral shape being displayed on the screen is the same as the original graphic pattern, the deformation ratio parameters obtained at that time are stored. Then, an image fed from an outside is converted based on the stored deformation ratio parameters and the converted image is displayed on the screen. The technology employed here is hereinafter called a “first conventional technology”.

Moreover, technology for another projection-type image display device as described below is disclosed, for example, in Japanese Patent Application Laid-open No. 2002-44571. That is, the disclosed projection-type image display device is provided with a displaying unit to project any of image each having a regularly polygonal as a test image on a screen, an inputting unit to input coordinates of a distortion-free test image corresponding to coordinates of a specified position defining a distortion contour of the image as the test image projected on the screen, a pointing device to move the specified position defining the distortion contour of the image projected as the test image to coordinates of the distortion-free test image input by using the above inputting unit, and a correcting unit to correct for distortion of projected image based on a relation between the coordinates of the specified position defining the distortion contour of the image projected as the test image and the coordinates corresponding to the distortion-free test image. The technology employed here is hereinafter called a “second conventional technology”.

However, the first conventional technology has a disadvantage in that, since a correcting processing is performed every time each of a plurality of correction points is designated, if time is required for the correcting processing, an operator cannot designate a subsequent correction point until the correcting processing is completed, thus causing low operability of the projection-type image display device.

Moreover, the above first conventional technology is built on premises that a same image as is displayed on a displaying unit making up an information processing device is projected on a screen by using an information processing device such as a personal computer or a like. Therefore, if the first conventional technology is applied to a case in which a projection-type image display device singly projects an image onto a screen, an additional display unit that has to be place independently of the screen is required, which causes increased part counts.

The second conventional technology also has a disadvantage in that, since a dedicated test image used to correct for distortions of projected images is required, a test image displaying unit used to create a test image and to display it must be additionally placed, which also causes the projection-type image display device to become costly.

### SUMMARY OF THE INVENTION

In view of the above, it is an object of the present invention to provide a distortion correcting method capable of correcting for distortions of projected images caused by projecting an image on a screen with a projection optical axis being tilted from normal to a screen, without a need for additionally placing a displaying unit or a test image displaying unit, and by a low-cost configuration and by a simple operation, a distortion correcting program of having a computer to correct for the distortions of the projected images and a projection-type image display device to which the above distortion correcting method is applied.

According to a first aspect of the present invention, there is provided a method for correcting for distortion of a projected image caused by projecting an image with a projection optical axis being tilted from normal to a screen, the method including:

a first step of moving a pointer on the screen according to operations of an operator, of sequentially displaying correction reference points corresponding to correction points for the projected image and being designated by operations of the operator on the screen, and then of displaying a correction contour frame on the screen, wherein the correction contour frame is obtained by connecting at least two being adjacent to each other out of the correction reference points;

a second step of determining the correction contour frame according to an instruction for determining the correction contour frame from the operator and of calculating a correction parameter according to a distance between each of the correction points for the projected image and the correction reference points of the correction contour frame corresponding to each of the correction points; and

a third step of correcting for the distortions of the projected image based on the correction parameter.

In the foregoing first aspect, a preferable mode is one wherein the correction points include first to fourth correction points and the projected image is divided into four portions including an upper-left portion, lower-left portion, upper-right portion and lower-right portion each corresponding to each of the first to fourth correction points and wherein the correction reference points include first to fourth correction reference points each corresponding to each of the first to fourth correction points.

Also, a preferable mode is one wherein, in the first step, in addition to the pointer, coordinate data of the pointer on the screen are displayed on the screen or in an operating section.

Also, a preferable mode is one wherein, wherein the correction contour frame is made up of a frame line having a first color and forming a rectangle and a frame line having a second color and being adjacent to the frame line having the first color from an inside of the rectangle.

Also, a preferable mode is one wherein the correction contour frame is made up of a frame line forming a rectangle, a cross line made up of two lines connecting two centers of two sides of the frame line facing each other, and a circular line approximately being inscribed in two long sides of the rectangle.

According to a second aspect of the present invention, there is provided a projection-type image display device for displaying a projected image on a screen including:

a displaying unit to move a pointer on the screen according to operations of an operator, to sequentially display correction reference points corresponding to correction points for the projected image projected with a projection optical axis being tilted from normal to the screen and being designated by operations of the operator on the screen, and then to display a correction contour frame on the screen, wherein the correction contour frame is obtained by connecting at least two being adjacent to each other out of the correction reference points;

a controlling unit to determine the correction contour frame according to an instruction for determining the correction contour frame from the operator and to calculate a correction parameter according to a distance between each of the correction points for the projected image and the correction reference points of the correction contour frame corresponding to each of the correction points; and

a correcting unit to correct for distortions of the projected image based on the correction parameter.

In the foregoing second aspect, a preferable mode is one wherein the correction points include first to fourth correction points and the projected image is divided into four portions including an upper-left portion, lower-left portion, upper-right portion and lower-right portion each corresponding to each of the first to fourth correction points and wherein the correction reference points include first to fourth correction reference points each corresponding to each of the first to fourth correction points.

Also, a preferable mode is one wherein the displaying unit displays, in addition to the pointer, coordinate data of the pointer on the screen.

Also, a preferable mode is one that wherein is provided with a remote controller having a display section on which coordinate data of the pointer on the screen are displayed.

Also, a preferable mode is one wherein the correction contour frame is made up of a frame line having a first color and forming a rectangle and a frame line having a second color and being adjacent to the frame line having the first color from an inside of the rectangle.

Furthermore, a preferable mode is one wherein the correction contour frame is made up of a frame line forming a rectangle, a cross line made up of two lines connecting two centers of two sides of the frame line facing each other, and a circular line approximately being inscribed in two long sides of the rectangle.

According to a third aspect of the present invention, there is provided a distortion correcting program to have a computer implement a method for correcting for distortion of a projected image caused by projecting an image with a projection optical axis being tilted from normal to a screen, the method including:

a first step of moving a pointer on the screen according to operations of an operator, of sequentially displaying correction reference points corresponding to correction points for the projected image and being designated by operations of the operator on the screen, and then of displaying a correction contour frame on the screen, wherein the correction contour frame is obtained by connecting at least two being adjacent to each other out of the correction reference points;

a second step of determining the correction contour frame according to an instruction for determining the correction contour frame from the operator and of calculating a correction parameter according to a distance between each of the correction points for the projected image and the correction reference points of the correction contour frame corresponding to each of the correction points; and

a third step of correcting for the distortions of the projected image based on the correction parameter.

With above configurations, since the distortion correcting method includes a first step of moving a pointer on a screen according to operations by an operator and of sequentially displaying correction reference points corresponding to correction points for a projected image and being designated by operations of the operator on the screen and, at a same time, displaying a correction contour frame being obtained by connecting at least two correction reference points being adjacent to each other, on the screen, a second step of determining a correction contour frame according to an instruction for determining the correction contour frame from the operator and of calculating a correction parameter according to a distance between each of correction points for the projected image and the correction reference points of the correction contour frame corresponding to each of the correction points, and a third step of correcting for distortions of projected images based on the correction parameter, distortions of a projected image caused by projecting image on the screen with a projection optical axis being tilted from normal to the screen can be corrected for, without the need for additionally placing a display unit or a test image displaying unit, by a low-cost configuration and by a simple operation.

### BRIEF DESCRIPTION OF THE DRAWINGS

The above and other objects, advantages, and features of the present invention will be more apparent from the following description taken in conjunction with the accompanying drawings in which:

FIG. 1 is a schematic perspective view to explain a distortion correcting method of projected images according to an embodiment of the present invention;

FIG. 2 is a schematic block diagram showing configurations of a projection-type image display device to which a method for correcting for distortions of projected images of the embodiment of the present invention is applied.

FIG. 3 is a front view showing an appearance of configurations of various keys serving as part of an operating section making up the projection-type image display device employed in the embodiment of the present invention;

FIG. 4 is a schematic diagram explaining the above distortion correcting method of the embodiment of the present invention;

FIG. 5 is a schematic diagram explaining a method of correcting for distortions of projected images according to a first modified example of the embodiment of the present invention; and

FIG. 6 is a schematic diagram explaining the method of correcting for the distortions of the projected images according to a second modified example of the embodiment of the present invention.

### DETAILED DESCRIPTION OF THE PREFERRED EMBODIMENTS

Best modes of carrying out the present invention will be described in further detail using various embodiments with reference to the accompanying drawings.

Embodiment

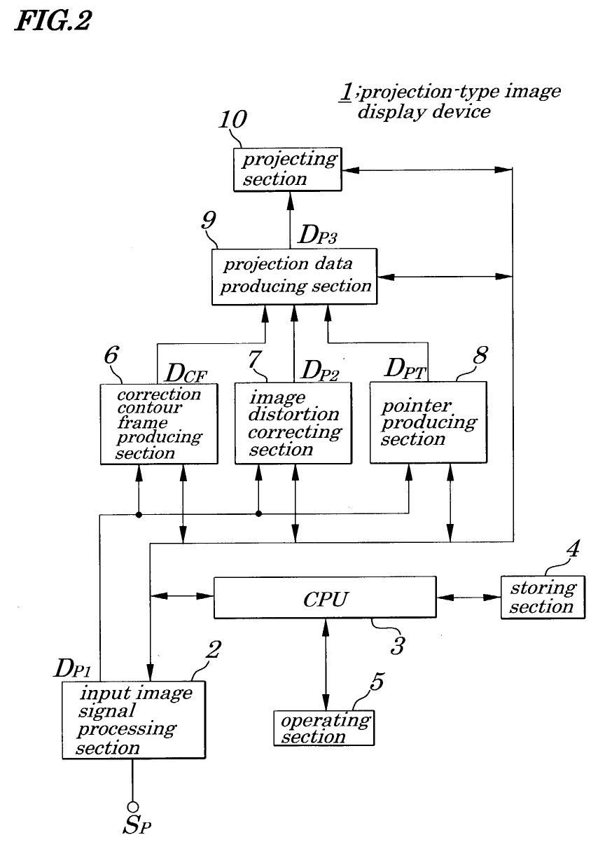

FIG. 2 is a schematic block diagram showing configurations of a projection-type image display device to which a method for correcting for distortions of projected images of a first embodiment of the present invention is applied. A projection-type image display device 1 of the first embodiment is made up of an input image signal processing section 2, a CPU (Central Processing Unit) 3, a storing section 4, an operating section 5, a correction contour frame producing section 6, an image distortion correcting section 7, a pointer producing section 8, a projection data producing section 9, and a projecting section 10.

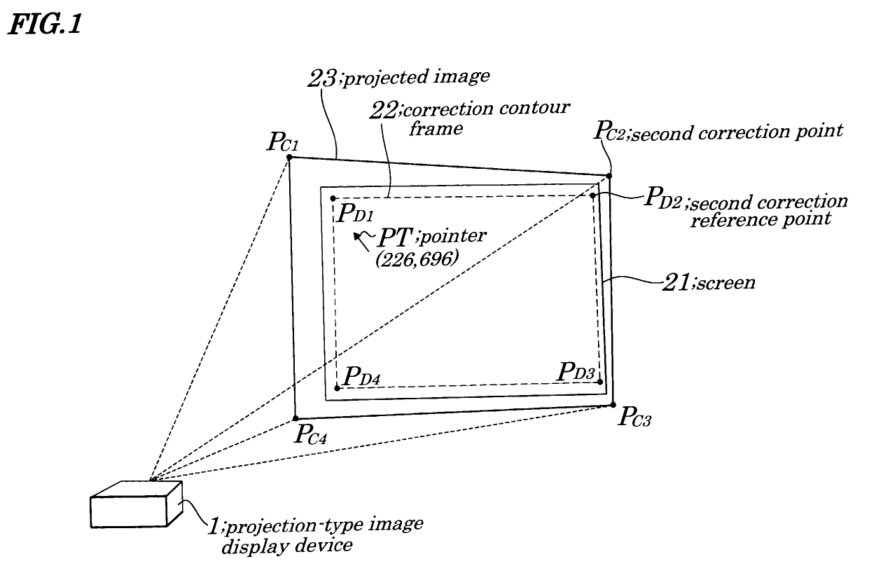

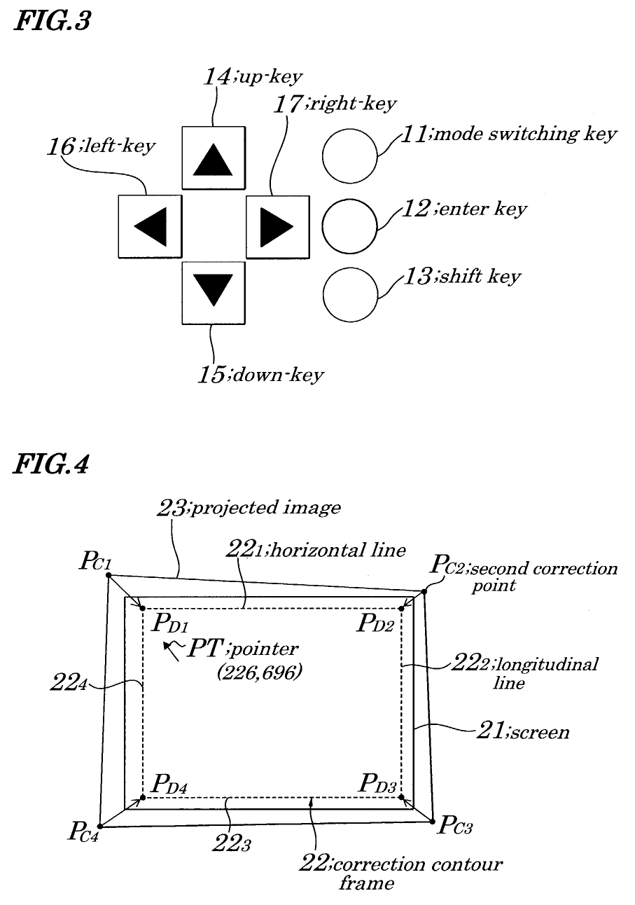

The input image signal processing section 2, under control of the CPU 3, after having converted an analog image signal S_{P} fed from an outside to digital image data, performs an inverse gamma correction or a like and feeds the result as image data D_{P1} to the correction contour frame producing section 6 and the image distortion correction section 7. The CPU 3 executes various kinds of programs being stored in the storing section 4 and controls each component making up the projection-type image display device 1 in order to display a projected image on a screen (not shown) according to operator manipulation of various keys constituting the operating section 5 by using various registers and/or flags being secured in the storing section 4. As the storing section 4, a semiconductor memory such as a RAM (Random Access Memory), ROM (Read Only Memory), flash memory, or a like, an FD (Flexible Disk), an HD (Hard Disk), an MO (Magneto-Optic) disk, a CD-ROM (Compact Disk Read-Only-Memory), a CD-R (Compact Disk-Readable), a CD-RW (Compact Disk-ReWritable), a DVD-ROM (Digital Video Disk-Read Only Memory), a DVD-R (Readable), a DVD-RW (Digital Video Disk-Rewritable), or a like can be used. The storing section 4 stores, in addition to a main program used to display projected image on the screen 21 based on the analog image signal Sp fed from an outside, an image distortion correction program to correct for distortion of projected image caused by projecting an image with a projection optical axis being tilted from normal to the screen or a like (that is, being tilted from normal to the screen face or a like). The operating section 5, as shown in FIG. 3, is made up of a mode switching key 11, an enter key 12, a shift key 13, an up-key 14, a down-key 15, a left-key 16, a right key 17, and other various switches (not shown) such as a power switch or a like which are all attached to a cabinet of the projection-type image display device 1 of the first embodiment and is so configured that a mouse and/or pointing devices such as a joystick, a trackball, a track pad, a pointing stick, or a like can be connected. Moreover, the operating section 5 has a light receiving section (not shown) to receive a light signal fed from a remote controller (not shown) and/or a display section (not shown) to display coordinates of a pointer PT (see FIG. 1 and FIG. 4) described later which is displayed on the screen. The operating section 5, when the keys 11 to 17, various switches, pointing devices, or remote controller (not shown) are manipulated by the operator, feeds signals corresponding to the manipulation of the keys 11 to 17, types of switches, kinds of light signals, and time during which such the keys or the like are pressed down, to the CPU 3.

The mode switching key 11 is used for providing an instruction for switching an operation mode of the projection-type image display device 1 of the embodiment from a correction mode to correct for distortions of an image to a normal mode to display a projected image on the screen. The enter key 12 is used, as shown in FIG. 4, for example, when a position of the pointer PT shown on a screen 21 is set as each of first to fourth correction reference points P_{D1} to P_{D4} in the correction mode. In FIG. 4, numbers (226, 696) represent coordinates of a position of the pointer PT. Providing that a display format of the projection-type image display device 1 of the embodiment employs an SXGA (Super Extended Graphics Array) model which provides 1280- by 1024-pixel resolution, a lower-left corner on the screen 21 is set as an origin point (0, 0) (not labeled), upper-left corner in the screen is set as coordinates (0, 1024) (not labeled), lower-right corner on the screen is set as coordinates (1024, 0) (not labeled), and upper-right corner on the screen is set as coordinates (1280, 1024) (not labeled), and a position of the pointer PT is displayed using coordinates as a relative position from the lower-left corner on the screen 21. A correction contour frame 22 described later, since it serves as a reference for correction of a projected image 23, is preferably a quadrilateral, that is, a rectangle or a square, and by displaying these coordinates of the pointer PT, a guideline can be provided to the operator to have each of the first to fourth correction reference points P_{D1} to P_{D4} set as each of the exact four corners of the rectangle. The shift key 13 is used to instruct the projection-type image display device 1 of the embodiment to start various processes when the mode switching key 11, the enter key 12, or a like are pressed down while the shift key 13 is being pressed down by the operator. For example, the operator, by pressing down the enter key 12 while pressing down the shift key 13, can start correction for distortions of images based on the above correction contour frame 22 set by the operator. Each of the up-key 14, the down-key 15, left-key 16, and the right-key 17 is used, in the correction mode as above, for selection of a position of each of the first to fourth correction reference points P_{D1} to P_{D4} of the correction_{contour} frame 22 displayed on the screen 21. The pointer PT shown in FIG. 4 moves on the screen 21 when the operator manipulates the up-key 14, the down-key 15, the left-key 16, the right-key 17, or the pointing device in order to select a position of each of the first to fourth correction reference points P_{D1} to P_{D4}.

Moreover, the remote controller (not shown) described above is also equipped with various keys having functions being equivalent to those of the mode switching key 11, the enter key 12, the shift key 13, the up-key 14, the down-key 15, the left-key 16, and the right key 17. Therefore, in descriptions below, the mode switching key 11, the enter key 12, the shift key 13, the up-key 14, the down-key 15, the left-key 16, and the right-key 17 represent either of the keys attached to the cabinet of the projection-type image display device 1 or the keys attached to a remote controller (not shown). The remote controller (not shown) may have the pointing device such as the trackball, the track-pad, the pointing stick, or the like. Moreover, the remote controller (not shown) has a display section or a like in which coordinates of the pointer PT and a like are displayed on the screen 21.

The correction contour frame producing section 6 produces, under control of the CPU 3, correction contour frame data D_{CF} for the correction contour frame 22 to be used to make a correction for distortions of projected images being displayed on the screen 21. The image distortion correcting section 7, under control of the CPU 3, produces image data D_{P2} by performing projected image distortion correction on the image data D_{P1} fed from the input image signal processing section 2. The pointer producing section 8, under control of the CPU 3, produces pointer data D_{PT} on a pointer to be displayed on the screen 21. Moreover, the projection-type image display device 1 is so configured that the image distortion correction section 7 does not perform any distortion correcting process on either the correction contour frame data D_{CF} produced in the correction contour frame producing section 6 or the pointer data D_{PT} produced in the pointer producing section 8.

The projection data producing section 9, under control of the CPU 3, produces final projection data D_{P3} by synthesizing correction contour frame data D_{CF} fed from the correction contour frame producing section 6, image data D_{P2} fed from the image distortion correcting section 7, and pointer data D_{PT} fed from the pointer producing section 8. The projecting section 10, generally, is made up of a display device, an optical lens, a light source lens, or a like (not shown) and, after having modulated light emitted from a light source using the display device based on the projection data D_{P3} fed from the projection data producing section 9, displays an image by magnifying an image using the optical lens (not shown) and by projecting it onto the screen 21. As the display device (not shown), in general, a liquid crystal panel, a device such as a DLP (Digital Light Processing) (trademark) device, or a like (not shown) are largely used. The DLP is one of methods of displaying projected images using a DMD (Digital Micromirror Device) made up of elements each being covered with several million pieces of small mirrors each being 13 μm square developed by Texas Instruments U.S.A. in which an image is projected by controlling an orientation of each of the above mirrors to reflect light from the light source.

Next, operations of the projection-type image display device 1 having the above configurations are described by referring to FIG. 1 to FIG. 4. Let it be assumed that the projection-type image display device of the embodiment is put in a normal mode in its initial state. FIG. 1 shows a schematic diagram illustrating a state in which the projection-type image display device 1 of the embodiment projects an image onto the screen 21 with a projection optical axis being tilted from normal to the screen 21. As shown in FIG. 1, the projected image 23, though it was originally rectangular, is distorted to be trapezoidal. In FIG. 1, each of four corners of the projected image 23 corresponds to each of the first to fourth correction points P_{C1} to P_{C4} which are objects to be corrected for. In the example, the projected image 23 shown in FIG. 1 is divided into four portions including an upper-left portion, upper-right portion, lower-right portion, and lower-left portion, each of which is used as an area in which each of the first to fourth correction points P_{C1} to P_{C4} can be set and each of first to fourth correction reference points P_{D1} to P_{D4} is made to correspond to each of the first to fourth correction points P_{C1} to P_{C4}. Then, first, the operator manipulates and instructs the mode switching key 11 to switch an operation mode of the projection-type image display device 1 from a normal mode to the correction mode for distortion correction.

Thus, by the operator manipulation of the mode switching key 11, the operating section 5 feeds a signal corresponding to the mode switching key 11 to the CPU 3. Therefore, since a distortion correcting program is read into the CPU 3 from the storing section 4, the CPU 3, through control on the distortion correcting program, controls and instructs the pointer producing section 8 to produce pointer data D_{PT} on the pointer PT to be displayed on the screen 21. Hereinafter, to simplify descriptions, particular processing to be performed by the CPU 3 is not described and operations by the operator are explained mainly.

As a result, as shown in FIG. 1 and FIG. 4, the pointer PT and coordinates of an end of the pointer PT are displayed on the screen 21 and, at a same time, the coordinates are displayed on a display section (not shown) making up the operating section 5 or on a display section (not shown) placed on the remote controller (not shown). Then, the operator, while making a reference to the pointer PT and its coordinates displayed on the screen 21, the display section (not shown) in the operating section 5 or the display section (not shown) in the remote controller (not shown), manipulates the up-key 14, the down-key 15, the left-key 16, the right-key 17, or the pointing device to move the pointer PT to an arbitrary position and to sequentially set each of the first to fourth correction reference points P_{D1} to P_{D4}.

As the operator sequentially sets each of the first to fourth correction reference points P_{D1} to P_{D4}, as shown by broken lines in FIG. 1 to FIG. 4, a horizontal line 22₁, a longitudinal line 22₂, a horizontal line 22₃, and a longitudinal line 22₄ all of which make up the correction contour frame 22, are sequentially displayed on the screen 21. In this case, in the image distortion correcting section 7, the distortion correction is made neither to the correction contour frame data D_{CF} being produced in the correction contour frame producing section 6 nor to the pointer data D_{PT} being produced in the pointer producing section 8 and their position and frame, while being renewed according to operations of the operator, are displayed on the screen 21. The correction contour frame 22 shown in FIG. 1 and FIG. 4 is similar to the screen 21 (aspect ratio being 3:4 or 9:16) having the shape of the rectangle and each of the first to fourth correction reference points P_{D1} to P_{D4} is positioned at each of four corner of the correction contour frame 22 forming a rectangle. Moreover, an order of setting the first to fourth correction reference points P_{D1} to P_{D4} is not specified in particular and setting may be started from any one of the first to fourth correction reference points P_{D1} to P_{D4} and either of clockwise or counterclockwise setting may be applicable so long as correction reference points being adjacent to each other are sequentially set. Moreover, each of the four corners of the frame itself of the screen 21, that is, for example a lower-left corner (0, 0), upper-left corner (0, 1024), lower-right corner (1024, 0), and upper-right corner (1280, 1024) maybe set as each of the first to fourth-correction reference points P_{D1} to P_{D4}.

Thereafter, if the operator wants to adjust a shape and size of the correction contour frame 22, by making a reference to the pointer PT or its coordinates being displayed on the screen 21, on the display section (not shown) in the operating section 5, or on the display section (not shown) in the remote controller (not shown), the operator manipulates the up-key 14, the down-key 15, the left-key 16, the right-key 17, or the pointing device to move the pointer PT to an arbitrary position and to sequentially reset each of the first to fourth correction reference points P_{D1} to P_{D4}. Then, the operator, when the shape and size of the correction contour frame 22 become what the operator originally intended to obtain, by pressing down the enter key 12 while pressing down the shift key 13, provides an instruction for start of correction for distortions of the image based on the correction contour frame 22 set by the operator. As a result, the CPU 3, after having calculated a correction parameter corresponding to a distance between each of the first to fourth correction points P_{C1} to P_{C4} for the projected image 23 and each of the first to fourth correction reference points P_{D1} to P_{D4} corresponding to each of the first to fourth correction points P_{C1} to P_{C4} of the correction contour frame 22, stores all the correction parameters obtained by the calculation into the storing section 4.

Then, the CPU 3, after having produced image data D_{P2} by controlling the image distortion correcting section 7 based on the correction parameter being stored in the storing section 4 to make image distortion correction to image data D_{P1} being fed from the input image signal processing section 2, feeds the image data through the projection data producing section 9 and the projecting section 10 to display a projected image obtained by correction on the screen 21.

Thus, according to the configurations employed in the embodiment, when distortions of projected images are corrected for, since the correction contour frame producing section 6 produces the correction contour frame 22 based on the first to fourth correction reference points P_{D1} to P_{D4} designated by the operator, the operator is allowed to provide an instruction for start of correction processing after having set the correction contour frame 22. As a result, unlike in the case of the first conventional technology, since it does not occur that the correction processing is performed every time one correction reference point is designated, even if much time is required for the correction processing, the operator can sequentially designate all the correction reference points, which serves to improve operability of the projection-type image display 1 of the present invention.

Moreover, according to the configurations employed in the embodiment, when distortions of projected images are corrected for, since the correction contour frame producing section 6 produces the correction contour frame 22 based on the first to fourth correction reference points P_{D1} to P_{D4} designated by the operator, unlike in the case of the second conventional technology, a test image displaying unit to a dedicated test image used to correct for distortions of projected images is not needed and, unlike in the case of the first conventional technology, a additional display unit being placed independently of the screen is not needed. Therefore, the projection-type image display device 1 can be configured to be simple and manufactured at low costs.

It is apparent that the present invention is not limited to the above embodiments but may be changed and modified without departing from the scope and spirit of the invention. For example, in the above embodiment, the example is shown in which the correction contour frame producing section 6, the image distortion correcting section 7, the pointer producing section 8, and the projection data producing section 9 are constructed of hardware. However, the present invention is not limited to this. That is, functions of the correction contour frame producing section 6, the image distortion correcting section 7, the pointer producing section 8, and the projection data producing section 9 may be programmed and a resulting program may be stored in the storing section 4 so that it is read from the storing section 4 into the CPU 3 to control operations of the CPU 3. The CPU 3, when the program is started, functions as the correction contour frame producing section 6, the image distortion correcting section 7, the pointer producing section 8, and the projection data producing section 9 and under control of the program, processing described above is performed.

Also, in the above embodiment, the example is shown in which a light signal is output from the remote controller to the operating section 5. However, the projection-type image display device 1 of the embodiment may be so configured that radio waves are emitted from the remote control to the operating section 5 and the operating section 5 receives the radio waves and converts them to electric signals.

Also, in the above embodiment, the example is shown in which the correction contour frame producing section 6 produces the correction contour frame 22 based on the first to fourth correction reference points P_{D1} to P_{D4} designated by the operator. However, any number of the correction reference points may be set as the correction reference points designated by the operator. In this case, also, same effects obtained by the above embodiment can be achieved.

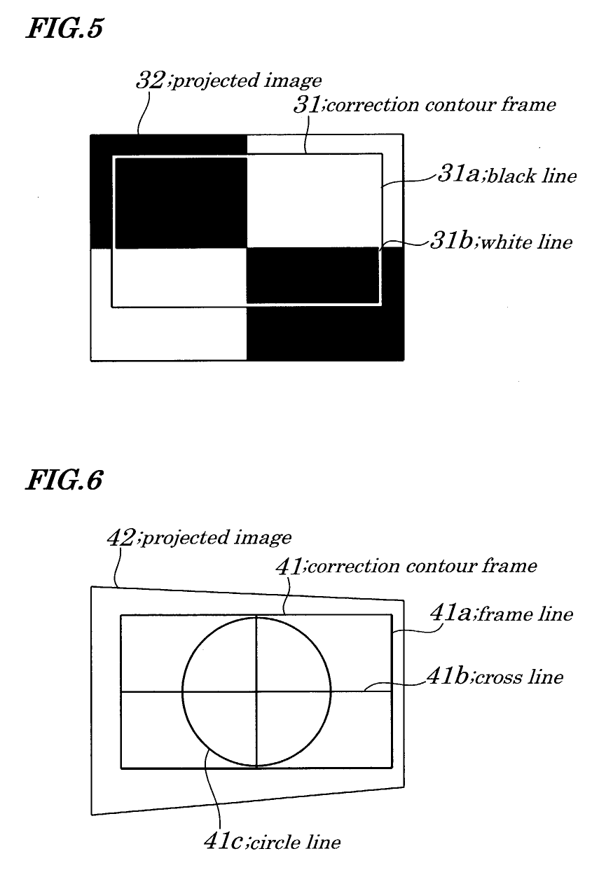

Also, in the above embodiment, the correction contour frame 22 is shown using broken lines forming a rectangle. However, as shown in FIG. 5 as a first modified example of the embodiment, the correction contour frame 31 may be made up of a black line 31a forming the rectangle and a white line 31b being adjacent to the black line 31a from an inside of the rectangle. In this case, the operator, whatever kind of image is projected, for example, even if a projected image 32 is checkered, can easily make a visual check. Moreover, colors of the two frame lines serving as the correction contour frame 31 are not limited to a black color and a white color and any color may be used so long as the color is visually checked easily that can include two colors being complementary to each other. The line being used as the correction contour frame 31 may be any one of a solid line, broken line, alternate long and short dashed line, or alternate long and two short dashed line.

Also, in the above embodiment, the example is shown in which the correction contour frame is shown using broken lines forming the rectangle. However, for example, as shown in FIG. 6 as a second modified example of the embodiment, the correction contour frame 41 may be made up of a frame line 41a forming a rectangle, a cross line 41b made up of two lines connecting two centers of two sides of the frame line 41a facing each other, and a circle line 41c approximately being inscribed in two long sides of the rectangle. By configuring as above, the operator can make a visual check easily on a positional relation between a projected image 42 and the correction contour frame 41 or a shape of the correction contour frame 41, which serves to further improve operability of the projection-type image display device 1 of the present invention. As the correction contour frame 41, any one of a solid line, broken line, alternate long and short dashed line, and alternate long and two short dashed line may be used.

What is claimed is:

1. A method for correcting for distortion of a projected image caused by projecting an image with a projection optical axis being tilted from normal to a screen, said method comprising:
a first step of moving a pointer on said screen according to operations of an operator, of sequentially displaying correction reference points corresponding to correction points for said projected image and being designated by operations of said operator on said screen, and then of displaying a correction contour frame on said screen, wherein said correction contour frame is obtained by connecting at least two being adjacent to each other out of said correction reference points;
a second step of determining said correction contour frame according to an instruction for determining said correction contour frame from said operator and of calculating a correction parameter according to a distance between each of said correction points for said projected image and said correction reference points of said correction contour frame corresponding to each of said correction points; and
a third step of correcting for said distortions of said projected image based on said correction parameter.

2. The method for correcting for distortions of a projected image according to claim 1, wherein said correction points include first to fourth correction points and said projected image is divided into four portions including an upper-left portion, lower-left portion, upper-right portion and lower-right portion each corresponding to each of said first to fourth correction points and wherein said correction reference points include first to fourth correction reference points each corresponding to each of said first to fourth correction points.

3. The method for correcting for distortions of a projected image according to claim 1, wherein, in said first step, in addition to said pointer, coordinate data of said pointer on said screen are displayed on said screen or in an operating section.

4. The method for correcting for distortions of a projected image according to claim 1, wherein said correction contour frame is made up of a frame line having a first color and forming a rectangle and a frame line having a second color and being adjacent to said frame line having said first color from an inside of said rectangle.

5. The method for correcting for distortions of a projected image according to claim 1, wherein said correction contour frame is made up of a frame line forming a rectangle, a cross line made up of two lines connecting two centers of two sides of said frame line facing each other, and a circular line approximately being inscribed in two long sides of said rectangle.

6. A projection-type image display device for displaying a projected image on a screen comprising:
a displaying unit to move a pointer on said screen according to operations of an operator, to sequentially display correction reference points corresponding to correction points for said projected image projected with a projection optical axis being tilted from normal to the screen and being designated by operations of said operator on said screen, and then to display a correction contour frame on said screen, wherein said correction contour frame is obtained by connecting at least two being adjacent to each other out of said correction reference points;
a controlling unit to determine said correction contour frame according to an instruction for determining said correction contour frame from said operator and to calculate a correction parameter according to a distance between each of said correction points for said projected image and said correction reference points of said correction contour frame corresponding to each of said correction points; and
a correcting unit to correct for said distortions of said projected image based on said correction parameter.

7. The projection-type image display device according to claim 6, wherein said correction points include first to fourth correction points and said projected image is divided into four portions including an upper-left portion, lower-left portion, upper-right portion and lower-right portion each corresponding to each of said first to fourth correction points and wherein said correction reference points include first to fourth correction reference points each corresponding to each of said first to fourth correction points.

8. The projection-type image display device according to claim 6, wherein said displaying unit displays, in addition to said pointer, coordinate data of said pointer on said screen, on said screen.

9. The projection-type image display device according to claim 6, provided with a remote controller having a display section on which coordinate data of said pointer on said screen are displayed.

10. The projection-type image display device according to claim 6, wherein said correction contour frame is made up of a frame line having a first color and forming a rectangle and a frame line having a second color and being adjacent to said frame line having said first color from an inside of said rectangle.

11. The projection-type image display device according to claim 6, wherein said correction contour frame is made up of a frame line forming a rectangle, a cross line made up of two lines connecting two centers of two sides of said frame line facing each other, and a circular line approximately being inscribed in two long sides of said rectangle.

12. A distortion correcting program to have a computer implement a method for correcting for distortion of a projected image caused by projecting an image with a projection optical axis being tilted from normal to a screen, said method comprising:
a first step of moving a pointer on said screen according to operations of an operator, of sequentially displaying correction reference points corresponding to correction points for said projected image and being designated by operations of said operator on said screen, and then of displaying a correction contour frame on said screen, wherein said correction contour frame is obtained by connecting at least two being adjacent to each other out of said correction reference points;
a second step of determining said correction contour frame according to an instruction for determining said correction contour frame from said operator and of calculating a correction parameter according to a distance between each of said correction points for said projected image and said correction reference points of said correction contour frame corresponding to each of said correction points; and
a third step of correcting for said distortions of said projected image based on said correction parameter.

13. A distortion correcting program according to claim 12, wherein said correction points include first to fourth correction points and said projected image is divided into four portions including an upper-left portion, lower-left portion, upper-right portion and lower-right portion each corresponding to each of said first to fourth correction points and wherein said correction reference points include first to fourth correction reference points each corresponding to each of said first to fourth correction points.

14. A distortion correcting program according to claim 12, wherein, in said first step, in addition to said pointer, coordinate data of said pointer on said screen are displayed on said screen or in an operating section.

15. A distortion correcting program according to claim 12, wherein said correction contour frame is made up of a frame line having a first color and forming a rectangle and a frame line having a second color and being adjacent to said frame line having said first color from an inside of said rectangle.

16. A distortion correcting program according to claim 12, wherein said correction contour frame is made up of a frame line forming a rectangle, a cross line made up of two lines connecting two centers of two sides of said frame line facing each other, and a circular line approximately being inscribed in two long sides of said rectangle.
